(19) United States
(12) Patent Application Publication
(10) Pub. No.: US 2011/0119337 A1
(43) Pub. Date: May 19, 2011

(54) System and Method for Electronic Messaging and Voicemail Management

(75) Inventor: Michael L. Bishop, Atlanta, GA (US)

(73) Assignee: AT&T Intellectual Property I, L.P., Reno, NV (US)

(21) Appl. No.: 12/621,548

(22) Filed: Nov. 19, 2009

(51) Int. Cl. G06F 15/16

(52) U.S. Cl. 709/206

(57) ABSTRACT

A method and system for electronic message management is provided. First and second messages are received at a computer messaging application and it is determined whether the second message is related to the first message. If the messages are related, the first message is incorporated into the second message and an indication that message have been incorporated into the second message is provided. Message incorporation can include selectively reproduction of the first message within the second message or a data base entry or meta-data indicating the determined relationship. An indication that the first message is related to the second message is displayed to the user of the computer messaging application. Incorporated messages can be moved to a designated storage location or deleted.

### FIELD OF THE INVENTION

The present invention relates to electronic messaging, and more particularly to the organization and management of electronic messages.

### BACKGROUND

Electronic messaging has largely subsumed the role of other forms of correspondence such as letters and telegraphs. Many of the modes of correspondence that pre-date the Internet have been updated for use within a computer messaging application. For example, facsimiles can now be delivered to an electronic mailbox or as an email attachment, and telephone messages (i.e., voicemails) are typically stored digitally and can be managed in a manner similar to emails.

This shift to digital or electronic correspondence has not only replaced more traditional modes of communication, but because of their low cost, near instantaneous delivery, and near ubiquitous access, the volume of such correspondence has greatly increased. A transaction that may have previously involved three or four facsimile transmissions has transformed into an email thread that includes all relevant parties each sending multiple emails. This increase in volume has resulted in many difficulties managing information, including in-boxes cluttered with multiple related messages.

Current computer messaging applications manage messages by sorting the data based on various message meta-data (e.g., sender, recipient, subject, date sent/received). Some computer messaging applications attempt to organize data in “threads” (i.e., grouping messages according to topic). Other organization and management schemes include storing messages in folders and/or associating labels or tags with various messages.

In view of the above, it is clear that improvements in electronic message management would be beneficial.

### SUMMARY OF THE INVENTION

In accordance with an aspect of the present invention a method and system for electronic message management is provided. After receiving a first and second message at a computer messaging application, it is determined whether the second message is related to the first message. If the messages are related, the first message is incorporated into the second message and an indication that one or more messages have been incorporated into the second message is provided.

The incorporation of the first message into the second message can include a variety of processes or the generation and/or transformation of data. In accordance with one feature of an embodiment of the present invention, the first message can be selectively copied either in part or in its entirety into the second message. In a further feature of an embodiment of the present invention, incorporation of the first message into the second message can include a database entry or generation and/or inclusion of meta-data indicating the determined relationship. In yet a further feature of an embodiment of the present invention, an indication that the first message is related to the second message is displayed within the computer messaging application.

Messages that are incorporated into another message can be moved or deleted. In one aspect of an embodiment of the present invention, the first message can be deleted. In a further aspect, the first message can be moved to a configurable folder or storage location. The content of incorporated messages can be viewed or retrieved, for example by viewing the content of the first message that was copied into the second message. Alternatively, in response to a selection of an indication in the second message, the computer messaging application can retrieve the first message from the designated folder or database for display to the user.

These and other advantages of the invention will be apparent to those of ordinary skill in the art by reference to the following detailed description and the accompanying drawings.

### BRIEF DESCRIPTION OF THE DRAWINGS

FIG. 1 illustrates a display of a computer messaging application in accordance with an embodiment of the present invention;

FIG. 2 illustrates a further display of a computer messaging application in accordance with an embodiment of the present invention;

FIG. 3 illustrates a further display of a computer messaging application in accordance with an embodiment of the present invention;

FIG. 4 is a flow diagram of a process in accordance with an embodiment of the present invention; and

FIG. 5 is a high-level block diagram of a computer in accordance with an embodiment of the present invention.

### DETAILED DESCRIPTION

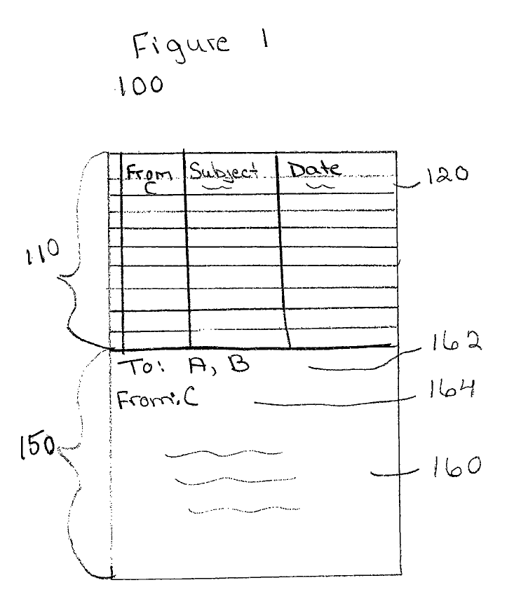

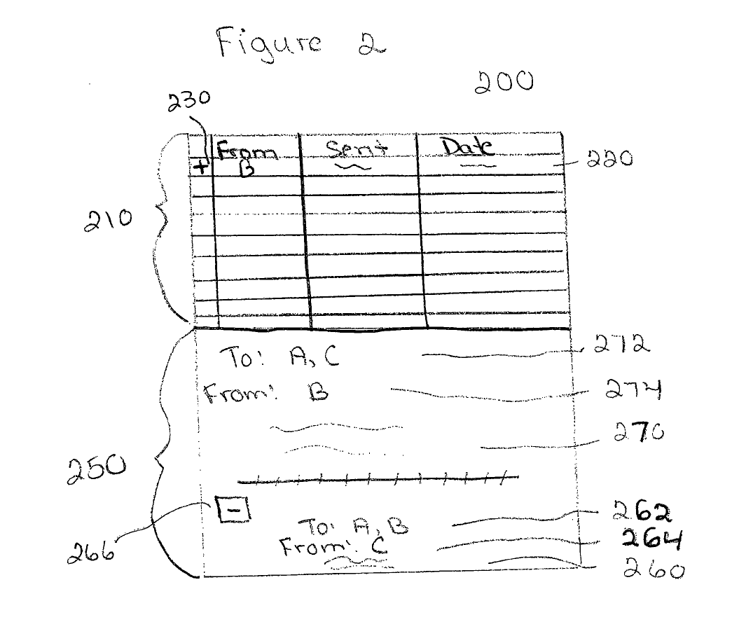

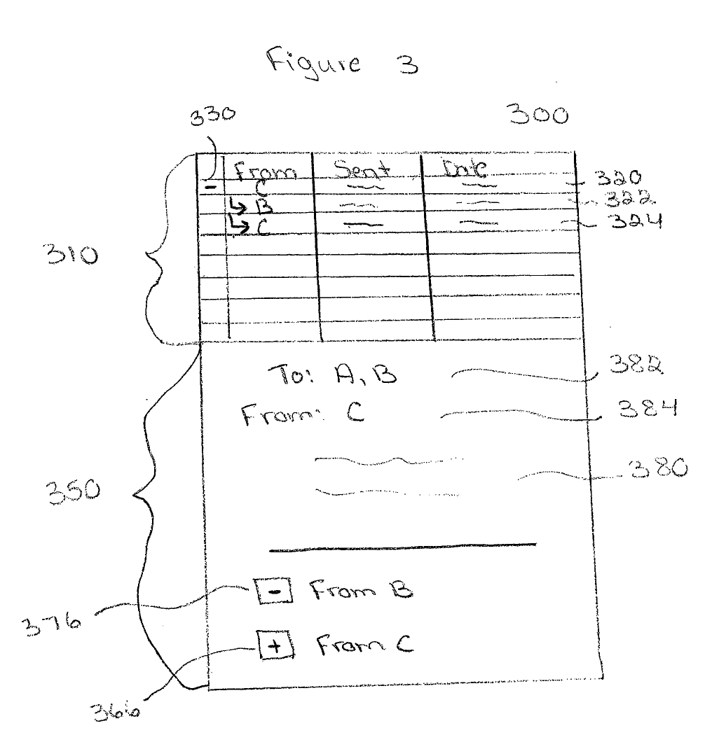

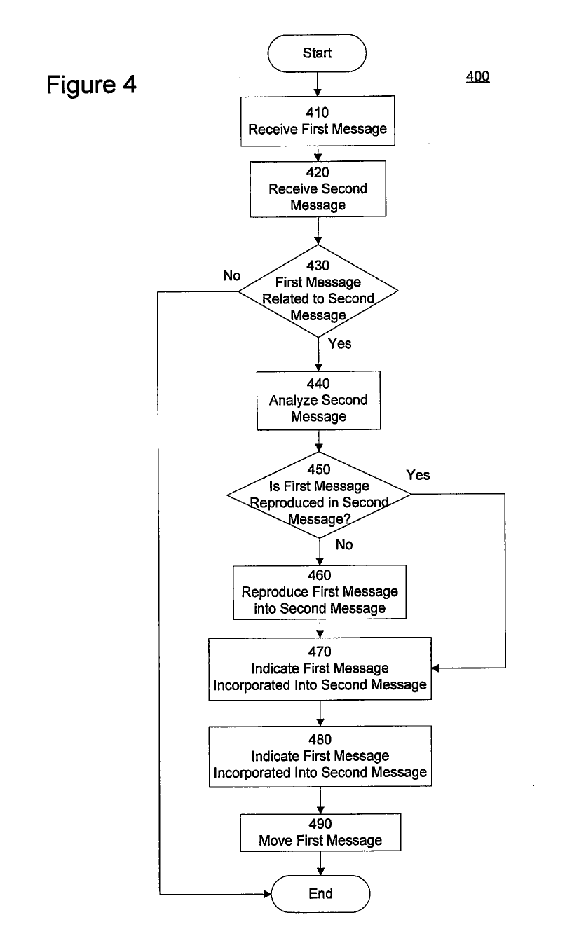

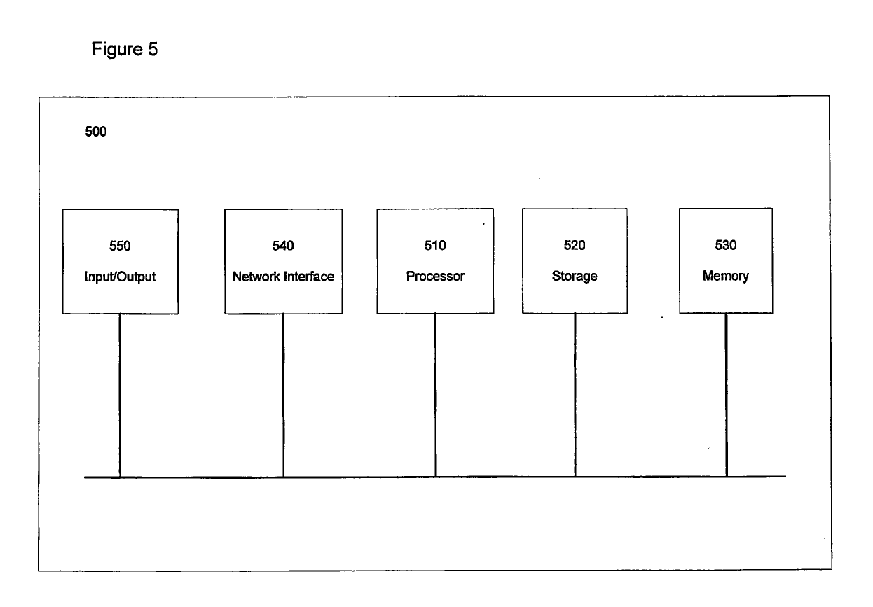

With reference to the Figures, FIG. 1, FIG. 2, and FIG. 3 illustrate a display of a computer messaging application (namely display 100, display 200, and display 300 respectively) at various states of processing and displaying messages. The computer messaging application can be a standalone application or an add-on (e.g., plug-in, library, module, extension, etc) to another messaging application. Each Figure is discussed individually below and is followed by a discussion of process 400 illustrated in FIG. 4 that can be implemented by the computer messaging application or computer system (e.g., the computer system illustrated in FIG. 5) to provide the various features and aspects of the present invention.

FIG. 1 illustrates a display 100 of a computer messaging application in accordance with an embodiment of the present invention. The display 100 is illustrated in a configuration that is common to many email applications. Specifically, the interface of display 100 includes a message list 110 and a message viewer 150. The message list 110 is typically a list of messages received by and/or sent from the user of the computer messaging application. For example, message list 110 is configured such that for each message, the sender (i.e., “From”), the subject, and the date of the message is displayed, as identified by labels in the top row of the message list 110.

In this example, the display 100 is associated with a user “A.” Exemplary message 120, which has been received by the computer messaging application, is displayed in the message list 110 and is from sender “C” to users “A” and “B.” Selection of message 120 in the message list 110 results in the message being displayed in the message viewer 150. The message viewer 150 typically displays the message body 160 and configurable meta-data concerning the message (e.g., header or envelope data) such as the message recipients 162 and message sender 164. A person of ordinary skill in the art would understand that the meta-data displayed in the message viewer 150 and the meta-data displayed in the message list 110 is typically user-configurable. Furthermore, a person of ordinary skill in the art would understand that the layout of the display 100 is merely exemplary and may be changed without impacting the scope of the invention.

FIG. 2 illustrates display 200 of the computer messaging application associated with user “A” after a second message 220 has been received. Display 200 has a layout that is similar to display 100, including a message list 210 that is similar to message list 110 and a message viewer 250 that is similar to message viewer 150. In accordance with the state of the computer messaging application illustrated in FIG. 2, upon receipt of the second message, the computer messaging application determined that it was related to the first message. Accordingly, the computer messaging application incorporated the first message into the second message and removed the list entry for message 120 from the default view of message list 210.

The message 220 in the message list 210 corresponds to the second message received. As displayed, message 220 in the message list 210 includes an indicator 230 that indicates one or more messages have been incorporated into message 220. Indicator 230 can be selected (e.g., toggled) to display a list of the messages that been incorporated into message 220.

Upon selection of message 220 in the message list 210, message viewer 250 displays the content of message 270 along with certain configurable meta-data such as the recipients 272 (i.e., To: A, C) and the sender 274 (i.e., From: B). Below message content 270, the message viewer 250 displays the incorporated messages, which in the present example is message 120, from C, to A and B. As configured, the message viewer 250 displays the content 260 of message 110 along with certain meta-data, such as the sender 264 and recipients 262 of the message. Additionally, indicator 266 is displayed which can be toggled to selectively display and hide the content and meta-data of the incorporated messages.

Thus, as illustrated in FIG. 2, when a second message is received by the computer messaging application that is related to a first message, the computer messaging application incorporates the first message into the second and provides an indicator that one or more messages have been incorporated into the second message. The indicator can include indicator 230 or indicator 266. Alternatively, the indicator can be the display of the first message along with the second message. Furthermore, it should be noted that in the configuration illustrated in display 200, the first message 110 has been removed from the message list 210. Thus, a user of the computer messaging application can be initially presented with only the most recent message in a group of related messages. While the incorporated and earlier related messages can be viewed or retrieved, the message list is not cluttered by multiple list entries related to the same topic.

FIG. 3 illustrates a display 300 of the computer messaging application associated with user “A” after a third message 320 has been received. Display 300 has a layout that is similar to display 100 and display 200, including a message list 310 that is similar to message lists 110 and 210 and a message viewer 350 that is similar to message viewers 150 and 250. In accordance with the state of the computer messaging application illustrated in FIG. 3, upon receipt of the third message, the computer messaging application determined that it was related to the first and second messages. Accordingly, the computer messaging application incorporated the second message, into which the first message was previously incorporated, into the third message.

The message 320 in the message list 310 corresponds to the third message received. As displayed, message 320 in the message list 310 includes an indicator 330 that indicates one or more messages have been incorporated into message 320. In FIG. 3, indicator 330 has been selected (e.g., toggled) such that the display 300 includes a list of the messages that have been incorporated into the third message 320. Specifically, below message 320, message list 310 includes a list of incorporated message 322 corresponding to the second message 220 and incorporated message 324 corresponding to first message 120. As previously discussed, selection of indicator 330 selectively toggles the display of incorporated messages 322 and 324 in the message list 310.

Upon selection of message 320 in the message list 310, message viewer 350 displays the message content 380 of message 320 along with certain configurable meta-data such as the recipients 382 (i.e., “To: A, B”) and the sender 384 (i.e., “From: C”). Below message content 380, the message viewer 350 can be configured to display meta-data associated with the incorporated messages. That is, message view 350 can include a display of meta-data information associated with the second message 220 and a display meta-data information associated with the first message 120. Meta-data information displays 376 and 366 can include indicators 366 and 376 which can be selectively toggled to display additional information associated with each incorporated message, such as additional meta-data and message content.

While the above discussion is limited to an example between participants A, B, and C, a person of ordinary skill in the art would understand that the concepts and processes of the present invention can be applied to various numbers of participants in a conversation. Additionally, participants can be added or removed from a series of messages. If a participant is removed from the distribution list of a new message, he or she will simply not receive the next message and any subsequent messages responding to the next message. If a new participant is added to the distribution list, because all previous messages have been incorporated in to the most recent message, the new participant will receive the most recent message along with all previous messages that have been incorporated. Transmitting the most recent message along with all previously incorporated messages can be accomplished in various ways depending on the configuration of the computer messaging application. If the computer messaging application is configured to reproduce the content of an incorporated message in a newly received message, when sending a new message to an additional participant, the computer messaging application need only transmit the message being replied to in the new message. Alternatively, if the computer messaging application is configured to incorporate messages by linking previously received messages to the most recent message by means of a database entry, meta-data, file link or other means of cross-referencing, the computer messaging application can be configured to detect new participants who have been added to a reply message, retrieve the cross referenced incorporated messages, and transmit the reply message along with the incorporated messages at least to each newly added participant.

As discussed above, the respective displays 100, 200, and 300 of FIGS. 1, 2, and 3 illustrate various states of the computer messaging application as messages are received and processed in accordance with an embodiment of the present invention. The process underlying the transition between these states is discussed below with respect to process 400 of FIG. 4.

In accordance with process 400, at step 410, a first message is received by a computer messaging application, and at step 420 a second message is received by the computer messaging application. The messages can include most types of electronic and digital messages including email, fax, instant message, and voicemail. At step 430, the computer messaging application that has received the first and second message determines whether the first message is related to the second message. If a first message is related to a second message, then the first message is related to all messages to which the second message is related.

Messages are related if one or more indicators, or a combination of indicators, are satisfied. An indicator of a relationship between messages can include the reproduction of a portion of the first message's contents within the second message, a subject line shared by two or more messages, or common meta-data such as header information or envelope information. Thus, in a further feature, a computer messaging application can insert identifying data in a message (e.g., header information, content encoding, envelope information, etc.) that will be propagated in all subsequent reply messages, such that each message that is received containing the identifying information is recognized by the computer messaging application as relating to other messages containing the identifying information. Further indicators of a relationship between messages include whether the new message is in reply to, or further to (e.g., forwarded or resent), a previous message.

The system can be configured such that various combinations of relationship indicators are used to determine that two messages are related. For example, the inclusion of pre-designated meta-data in the message's header information, by itself, can determine that two messages are related. However, if no such meta-data is present, the system may be further configured to determine that two messages are related if both the new message reproduces a portion of an older message's contents and the messages have a common subject line. Thus, the system can be configured with multiple rules defining whether messages are related, and those rules can be evaluated in hierarchy until a determination is made.

If the computer messaging application determines the second message is not related to the first message, process 400 ends, and the computer messaging application continues to operate (e.g., receiving and processing incoming messages). However, if the computer messaging application determines the second message is related to a previous message (i.e., the first message), the computer messaging application analyzes the second message at step 440. In accordance with one aspect of the present invention, because messaging programs sometimes incorporate the message being replied to within the reply message, at step 440 the computer messaging application can determine whether the first message is reproduced, either partially or wholly, within the second message.

At step 450, the computer messaging application checks whether the first message was entirely reproduced within the second message based on the analysis at step 440. If the first message is reproduced in the second message, the computer messaging application proceeds to step 470. Alternatively, if the first message is only partially reproduced within the second message, or not reproduced at all, the computer messaging application can complete the reproduction of the first message (i.e., fill in any missing parts of the first message) or reproduce the first message in its entirety at step 460.

The computer messaging application indicates that the first message has been incorporated into the second message at step 470. Incorporation of the first message into the second message can encompass the reproduction of the first message into the second message at step 460. Alternatively, incorporation of the message can include linking the second message to the first message. Linking messages can be achieved by inserting a hyperlink or other cross-reference link into either the meta-data (e.g., header or envelope information) or content of the message. Alternatively, the computer messaging application can store an association between the two messages in a database.

An indication that the first message was incorporated into the second message is provided at step 480. The indication is frequently visual within the display of the computer messaging application. For example, indicator 230 and 266 in display 200 and indicators 330, 376, and 366 in display 300 can be provided to provide a cue that messages have been incorporated. Alternative indicators include changes to fonts or colors within a message list or message viewer.

Messages that have been incorporated into other messages are optionally moved at step 480. In accordance with one feature of the present invention, if the first message has been fully reproduced within the second message, the first message can be deleted or moved to a folder for deleted messages. Alternatively, the first message can be moved to a configurable folder or other configurable storage location for incorporated messages.

As part of moving the first message at step 480, the display of the computer messaging application preferably “hides” the first message. That is, preferably, the first message is removed from the default message list of the display. In this manner, the default message list is not cluttered with multiple messages for the same topic. If the user of the computer messaging application desires to see which messages have been incorporated into a particular message, the user can toggle the view, for example by selecting indicator 230 or 330. If the user of the computer messaging application desires to see the content of the messages that have been incorporated into a particular message, the user can toggle the display of the incorporated message content, for example by selecting indicator 266, 376, or 366.

The above-described methods for managing electronic messages can be implemented on a computer using well-known computer processors, memory units, storage devices, computer software, and other components. A high-level block diagram of such a computer is illustrated in FIG. 5. Computer 500 contains a processor 510 which controls the overall operation of the computer 500 by executing computer program instructions which define such operations. The computer program instructions may be stored in a storage device 520, or other computer readable medium (e.g., magnetic disk, CD ROM, etc.), and loaded into memory 530 when execution of the computer program instructions is desired. Thus, the method steps of FIG. 4 can be defined by the computer program instructions stored in the memory 530 and/or storage 520 and controlled by the processor 510 executing the computer program instructions. For example, the computer program instructions can be implemented as computer executable code programmed by one skilled in the art to perform an algorithm defined by the method steps of FIG. 4. Accordingly, by executing the computer program instructions, the processor 510 executes an algorithm defined by the method steps of FIG. 4. The computer 500 also includes one or more network interfaces 540 for communicating with other devices via a network. The computer 500 also includes input/output devices 550 that enable user interaction with the computer 500 (e.g., display, keyboard, mouse, speakers, buttons, etc.) One skilled in the art will recognize that an implementation of an actual computer could contain other components as well, and that FIG. 5 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention. The various functional modules that are shown are for illustrative purposes only, and may be combined, rearranged and/or otherwise modified.

We claim:

1. A method of electronic message management comprising:
receiving a first message at a computer messaging application;
receiving a second message at the computer messaging application, subsequent to receiving the first message;
determining the second message is related to the first message;
incorporating the first message into the second message; and
indicating that the one or more message have been incorporated into the second message.

2. The method of claim 1, wherein incorporating the first message into the second message comprises reproducing the first message is reproduced within the second message.

3. The method of claim 1, wherein incorporating the first message into the second message comprises displaying an indication that the first message is related to the second message.

4. The method of claim 1, further comprising removing the first message from an interface of the computer messaging application.

5. The method of claim 4, further comprising displaying at least a portion of the one or more messages in response to a user selection of the indication.

6. The method of claim 1, further comprising moving the first message to a storage location subsequent to incorporating the first message into the second message.

7. The method of claim 1, wherein determining the second message is related to the first message comprises comparing header information of the first message and header of the second message.

8. The method of claim 1, further comprising displaying the first message in response to receiving a predetermined user-interaction with a display of the second message.

9. A system for electronic message management comprising:
means for receiving a first and second message at a computer messaging application;
means for determining the second message is related to the first message;
means for incorporating the first message into the second message; and
means for removing the first message from a display of the computer messaging application.

10. The system of claim 9, wherein the means for incorporating the first message into the second message further comprises means for copying at least a portion of the first message into the second message.

11. The system of claim 9, wherein the means for incorporating the first message into the second message comprises means for storing an indication that the first message is related to the second message.

12. The system of claim 9, further comprising means for indicating that one or more messages have been incorporated into the second message.

13. The method of claim 12, further comprising means for displaying at least a portion of the one or more messages in response to a user selection of the indication.

14. The system of claim 9, further comprising means for moving the first message to a predetermined storage location.

15. The system of claim 9, wherein the means determining the second message is related to a first message comprises means for comparing predetermined header information of the first message and predetermined header of the second message.

16. The system of claim 9, further comprising displaying the first message in response to receiving a predetermined user-interaction with a display of the second message.

17. A computer readable medium encoding a computer program for execution on a computer that when executed is configured to:
receive a first message;
receive a second message, subsequent to receiving the first message;
determine the second message is related to the first message;
incorporate the first message into the second message; and
indicate that the one or more message have been incorporated into the second message.

18. The computer readable medium of claim 17, wherein the computer readable medium is further configured to reproduce at least a portion of the first message within the second message.

19. The computer readable medium of claim 17, wherein the computer readable medium is further configured to move the first message to a storage location subsequent to incorporating the first message into the second message.

20. The computer readable medium of claim 17, wherein the computer readable medium is further configured to remove the first message from an interface of the computer messaging application.
